(19) United States
(12) Patent Application Publication
(10) Pub. No.: US 2009/0057130 A1
(43) Pub. Date: Mar. 5, 2009

(54) Method of manufacturing particle wire

(75) Inventors: Hiroshi Morita, Yotsukaido-shi (JP); Kohsuke Abe, Matsudo-shi (JP); Koh Hattori, Tokyo (JP); Hiroyuki Sakano, Chiba-shi (JP); Chiba Yamano, Yokohama-shi (JP)

Correspondence Address: MORGAN LEWIS & BOCKIUS LLP, 1111 PENNSYLVANIA AVENUE NW, WASHINGTON, DC, 20004, US

(73) Assignee: National University Corporation Chiba University

(21) Appl. No.: 12/068,643

(22) Filed: Feb. 8, 2008

(30) Foreign Application Priority Data
Aug. 27, 2007 (JP) 2007-219987

(51) Int. Cl. B01J 19/08

(52) U.S. Cl. 204/157.63

(57) ABSTRACT

A method of manufacturing a microwire or a nanowire formed of a metal-containing compound having a desired composition, including the steps of:

(1) preparing a vapor or gas of an organometal compound and, if required, a vapor or gas of an optically excitable organic compound and/or a vapor or gas of reactive organic compound;

(2) introducing the vapor or gas prepared in the step (1) into a reaction vessel; and

(3) irradiating the vapor or gas introduced into the reaction vessel in the step (2) with a light having a wavelength which is absorbed by at least one of the organometal compound and the optically excitable organic compound.

### BACKGROUND OF THE INVENTION

1. Field of the Invention

The present invention relates to a method of manufacturing a particle wire which has a linear structure formed of particles connected to each other. More specifically, the present invention relates to the method of manufacturing the particle wire in the gas phase utilizing photochemical reaction.

2. Description of the Related Art

In recent years, filament structures such as microwires and nanowires having thickness in the order of micrometers to nanometers have been attracting attention for use of wiring materials of electronic devices and catalyst materials, for example.

There are some known methods of manufacturing such wires (see Japanese Unexamined Patent Application Publication (Kokai) No. 2006-161102 and Japanese Unexamined Patent Application Publication (Kokai) No. 2007-55836, for example).

### SUMMARY OF THE INVENTION

However, currently, only limited types of microwires and nanowires are practically manufactured. In view of the foregoing, the present invention is directed to provide a method of manufacturing microwires and nanowires formed of a metal-containing compound having a desired chemical composition.

The present inventors have already found that spherical particles involving composite organometal compounds can be produced by inducing photochemical reaction of gaseous organometal compounds under light irradiation. As a result of further investigation of this particle formation, the present inventors have found that linearly aggregated structures (particle wires) composed of the particles chemically connected to each other in series can be manufactured by controlling convection of the gas containing the formed aerosol particles, resulting in the accomplishment of the present invention.

Specifically, the present invention is as follows.

A method of manufacturing a particle wire formed of particles connected to each other, including the steps of:

(1) preparing a vapor or gas of an organometal compound and, if required, a vapor or gas of an optically excitable organic compound and/or a vapor or gas of a reactive organic compound;

(2) introducing the vapor or gas prepared in the step (1) into a reaction vessel; and

(3) irradiating the gas introduced into the reaction vessel in the step (2) with a light having a wavelength which is absorbed by at least one of the organometal compound and the optically excitable organic compound.

According to the present invention, it is possible to manufacture a metal-containing particle wire having a desired chemical composition by appropriately selecting a kind of organometal compound with suitable chemical reactivity as a reactant.

### BRIEF DESCRIPTION OF THE DRAWINGS

FIG. 1 is a schematic drawing of an example of a reactor used for manufacturing the particle wire according to the present invention;

FIG. 2 is a SEM image of a particle wire obtained in the first embodiment;

FIG. 3 is a SEM image of the particle wire obtained in the second embodiment;

FIG. 4 is a SEM image of the particle wire obtained in the third embodiment;

FIG. 5 is a SEM image of the particle wire obtained in the fourth embodiment;

FIG. 6 is a SEM image of the particle wire obtained in the fifth embodiment;

FIG. 7 is a SEM image of the particle wire obtained in the sixth embodiment;

FIG. 8 is a SEM image of the particle wire obtained in the seventh embodiment; and

FIG. 9 is a SEM image of the particle wire obtained in the eighth embodiment.

### DETAILED DESCRIPTION OF THE INVENTION

Hereinafter, the present invention will be described concretely.

First, the step (1) will be described.

In the step (1), a vapor or gas of a raw material necessary for manufacturing particles is prepared. In the present invention, an organometal compound is used as the raw material for manufacturing the particles. By selecting a kind of organometal compound with suitable chemical reactivity, the particles with a desirable chemical composition can be manufactured. Depending on the chemical composition to be tailored, single or several kinds of the organometal compounds may be used.

Any organometal compound may be used in the present invention as long as it can vaporize or sublime at a reaction temperature, regardless of its phase (solid, liquid, or gas) at room temperature.

In the present invention, a transition-metal carbonyl compound which evaporates at a relatively low temperature can be preferably used as the organometal compound. Specific examples of the transition-metal carbonyl compound include, but are not limited to, Co(CO)₃NO, Co₂(CO)₈, Fe(CO)₅, Ni(CO)₄, and the like.

In the present invention, for the purpose of controlling the morphology of the product and improving the mechanical strength of a particle wire, it is preferable to add an optically excitable organic compound to the gas phase as the second component. Any organic compound which is solid, liquid, or gas at room temperature may be used as such an optically excitable organic compound as long as it can be vaporized at the reaction temperature and can be excited by one-photon absorption to show chemical reactivity under light irradiation in the step (3).

Addition of the optically excitable organic compound to the gas phase makes it easy to form spherical particles, and thus the particle wire having a uniform thickness. In addition, by adding the optically excitable organic compound to the gas phase, the adjacent particles in the wire can be chemically bonded to each other at their contacting points, so as to increase the mechanical strength of the particle wire. In order to further increase the bonding strength between the particles, the optically excitable organic compound is preferred to induce polymerization reaction.

As a typical example of the optically excitable organic compounds, carbon disulfide (CS₂) can be used. Acrorein (CH₂═CH—CHO) and some acrylic acid esters, such as methyl acrylate (CH₂═CH—CO—O—CH₃), can also be used as the optically excitable organic compounds.

More than two optically excitable organic compounds may be used at one time.

Moreover, in the present invention, a reactive organic compound may be added to the gas phase for the purpose of controlling a photochemical reaction rate, morphology of the product, and/or the size of the produced particles. Here, the reactive organic compound is an organic compound except for the organometal compounds, which is not excited by one-photon absorption under light irradiation in the step (3). Typical examples include allyltrimethylsilane (ATMeSi) or trimethylsilyl azide.

According to the study by the present inventors, it has been observed in many photochemical reactions of the organometal compounds that the reaction rate increased by the addition of the reactive organic compounds, although the reactive organic compound itself participated only in a small amount. This phenomenon is noticeably observed for the case where Co(CO)₃NO and ATMeSi are used as the organometal compound and the reactive organic compound, respectively.

More than two reactive organic compounds may be used in one time.

In cases where the organometal compound, the optically excitable organic compound, and/or the reactive organic compound are solid or liquid, any methods available to vaporize them into the gas can be used, including the methods of sublimation or evaporation under reduced pressure or by heating as an example. For the liquid compounds, it is recommended to purify them by vacuum distillation prior to vaporization in order to lower the boiling point.

Next, the step (2) will be described.

In the step (2), the vapor or gas prepared in the step (1) is introduced into a reaction vessel, such as a glass cell. At this time, it is desirable to evacuate air from the reaction vessel for avoiding reaction inhibition by oxygen.

The size and the shape of the reaction vessel is not limited. Depending on an amount of production and others, they may be appropriately determined. In the larger and deeper reaction vessel, the longer particle wires tend to be produced.

By controlling the amount (partial pressure) of the organometal compound introduced into the reaction vessel, the photochemical reaction rate in the step (3), a mean diameter of the particles (i.e., primary particles) to be produced, and the length of the particle wire (i.e. the number of the particles connected to each other) can be controlled.

Although the partial pressure of the organometal compound is not specified, the higher pressure may cause the higher photochemical reaction rate, resulting in the production of a microcrystalline product instead of the particles. On the contrary, when the partial pressure is too low, it takes longer time to produce the particles. Accordingly, the total partial pressure of the organometal compounds present in the reaction vessel is preferably 0.1 to 30 Torr, or is preferably 0.1 to 10 Torr if the optically excitable organic compound and/or ATMeSi coexists.

When the gas is composed of several kinds of gaseous molecules, each kind of gaseous molecules is introduced successively into the reaction vessel to prepare a gaseous mixture. By adjusting the partial pressure of each kind of gaseous molecules, the photochemical reaction rate in the step (3), the chemical composition and the mean diameter of the produced particles (i.e., primary particles), the length of the particle wire, and others can be controlled.

The partial pressure of the optically excitable organic compound is not limited. Under a too high pressure, photochemical reaction among the organic compounds may be accelerated, resulting in the less amount of the organometal compound in the particles, or resulting in the formation of a film instead of the particles. Hence, the partial pressure of the optically excitable organic compound is preferable to be 0.1 to 10 times of the (total) partial pressure of the organometal compound.

The partial pressure of the reactive organic compound is not limited. Under a too high pressure, chemical reaction may be accelerated, resulting in the formation of a film instead of the particles. Hence, the partial pressure of the reactive organic compound is preferable to be 1 to 10 times of the (total) partial pressure of the organometal compound,

Next, the step (3) will be described.

In the step (3), by irradiating the gas introduced into the reaction vessel in the step (2) with the light having the wavelength which is absorbed by at least one of the organometal compound and the optically excitable organic compound, the organometal compound and/or the organic compound are excited to induce the photochemical reaction of the organometal compound.

During such photochemical reaction, the organometal compound and other gaseous components, if any, react in each other and produce the composite particles involving chemical species originating from these gaseous compounds.

The produced particles travel in the gas phase until they collide with a substrate at the bottom of the reaction vessel. During the traveling, they grow by colliding with gaseous molecules and with other particles to form the larger spherical particles.

The mean diameter of the primary particles deposited on the substrate is in the order of several nanometers to 1 micrometer, depending on the kinds of the raw materials of the organometal compound and the organic compound, and on the conditions of light irradiation as well.

The wavelength of the irradiation light is in the wavelength region of the absorption bands of either the organometal compound or the optically excitable organic compound in the gas phase. Although the wavelength of the irradiation light suitable for the production of the particle wires depends on the kind of the organometal compound and the optically excitable organic compound to be used, an ultraviolet region between 250 to 400 nm is preferable when the transition-metal carbonyl compound is used as the organometal compound. By varying the wavelength of the irradiation light, the photochemical reaction rate, the chemical composition and the mean diameter of the produced particles (primary particles), and others can be controlled.

A variety of the light source can be used for light irradiation. As examples, stationary light from a medium pressure mercury lamp combined with a filter, and pulsed laser light of a YAG laser (the third harmonic (355 nm) and the fourth harmonic (266 nm)), a N2 laser (337 nm),and others can be used.

Although the intensity of the irradiation light is not specifically limited, the photochemical reaction rate depends predominantly on the intensity of the irradiation light. Since the too high photochemical reaction rate may result in the production of amorphous deposits or the film instead of the particles, the intensity of the irradiation light is preferably not too high. Thus, in the case where the stationary light source such as a medium pressure mercury lamp is used, the intensity thereof is preferably in the range between 0.1 to 100 mJ/cm²·s, and more preferably between 1 to 10 mJ/cm²·s. In addition, in the case where a pulse laser light source (with a repetition rate of approximately 1 to 100 Hz) is used as the light source, the intensity thereof is preferably in the range between 0.1 to 100 mJ/pulse·cm², and more preferably in the range between 1 to 10 mJ/pulse·cm², by adjusting the light intensity by defocusing pulsed laser light with a concave lens or the like, for example. By adjusting the intensity of the irradiation light, the photochemical reaction rate, the mean diameter of the particles (primary particles) to be produced, particle size distribution, and others can be controlled.

The light irradiation on the gas is preferably started after a sufficient period of elapsed time in order for the gas to uniformly diffuse within the reaction vessel after introducing the gas into the reaction vessel in the step (2). If the gas molecules do not distribute homogeneously within the reaction vessel, the control of the convectional motion due to light irradiation, which will be described later, may become difficult, and the chemical composition of the particles may become inhomogeneous or the diameter of the particles may not be uniform. Hence, the formation of the particle wire itself and then the particle wire having a uniform thickness may become difficult.

In the present invention, the produced particles are linearly connected to each other in series by controlling both the convectional flow and speed of the reaction gas in the step (3). This may be due to the fact that the produced particles moving in the gas phase under a regulated convectional flow collide against the inner wall of the reaction vessel and a substrate placed in the reaction vessel from one direction, so that the particles tend to sequentially collide and accumulate at the end of the linear wire.

As described above, it is considered that the particles are linearly connected to each other when the particles collide against the inner wall of the vessel and against the substrate. To improve the efficiency of forming particle wires, it is important to prepare the space for collision inside the reaction vessel. In a cylindrical vessel, particles do not effectively collide against the round inner wall of the reaction vessel due to the convectional flow along the inner wall. Thus, in order to increase the collision space for the particles, it is preferable to use the reaction vessel with such a shape which has a part of varying curvature, that is, a part of the negative or zero curvature being connected to a part of the positive curvature, for example, or a shape with a bottom surface of which curvature abruptly varied such as a semicylindrical shape, or otherwise to use a reaction vessel together with a substrate placed at the bottom.

Although methods of controlling the convection are not limited and the desired convectional flow may be generated intentionally by installing a ventilator or heater in the reaction vessel, the present inventors have found that the convection can be easily controlled by controlling the conditions of light irradiation without using any special devices.

Specifically, it has been found that the produced particles are aligned to form the particle wire under a convectional flow which is induced under the intermittent light irradiation or under stationary light irradiation during a short period of time shorter than a predetermined period of time.

Although it is not clarified in detail how the convection can be influenced by changing the conditions of light irradiation it is considered that, in the closed reaction vessel without any forced motion, the convectional flow is induced by the temperature change caused by heat release due to relaxation of excited gaseous components and by density fluctuation of the gas components accompanied by photochemical reaction. Thus, the convectional motion and its speed can be controlled by adjusting the light irradiation conditions in the photochemical reaction to result in temperature change and density fluctuation of the gas components.

In order to control the convection under stationary light irradiation for a short period of time, the irradiation time should be less than a predetermined period of time. In the present invention, particles were produced by varying light irradiation time in order to determine the critical time for light irradiation, i.e the longest period of time at which the particle wire was no longer formed. The critical time for light irradiation is defined as aforementioned predetermined period of time. The critical time for light irradiation (predetermined period of time) of the irradiation time depends on the kinds of the optically excitable organometal compound and/or organic compound, the combination and the partial pressure of the compounds, the reaction temperature, and the light intensity. For example, when transition-metal carbonyl compound is employed as the organometal compound, the critical time is approximately 1 minute to several tens of minutes.

In order to control the convection under the intermittent light irradiation, the light irradiation conditions may be determined appropriately depending on the kinds of the optically excitable organometal compound and/or organic compound, the combination and the partial pressure of the compounds, the reaction temperature, and the light intensity. For example, the repeated irradiation of a few seconds to 10 minutes can be performed with a periodical or non-periodical interval of several tens of seconds to 10 minutes.

The formed particle wire tends to become longer when the convectional flow is controlled under the intermittent light irradiation, compared to the case controlled under stationary light irradiation for a short time.

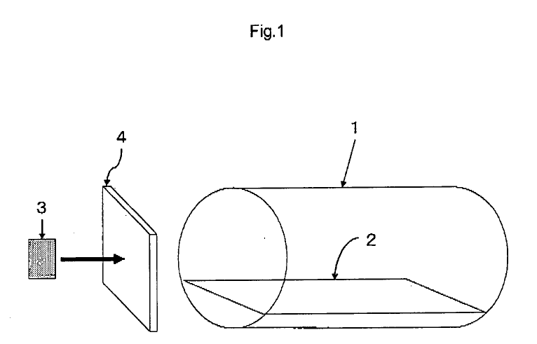

FIG. 1 shows a schematic view illustrating an example of a reactor which can be used to manufacture the particle wires in the present invention.

In FIG. 1, a glass cell is used as a reaction vessel 1. A substrate 2 is placed in the reaction vessel 1. The particle wire is manufactured on this substrate and collected. Since the surface of each particle constituting the particle wire is highly reactive as deposited on the substrate, it is required that the material of the substrate 2 is not reactive against the formed particles. Materials such as copper, aluminum, glass, and the like can be used.

In FIG. 1, the photochemical reaction of the gas takes place within the reaction vessel 1 under ultraviolet light irradiation at 313 nm with a medium pressure mercury lamp 3 through a glass filter 4.

Although the particle wire manufactured by the present invention is composed of composite organometal compounds, it can be converted to a conductive wire composed of metal or alloy by evaporating organic substances with post-baking.

In addition, by post-exposure upon the particle wire with the light between 250 to 400 nm, carbonyl groups can be evolved from the particles, thereby the organic substances can be eliminated.

The length of the particle wire to be manufactured may be appropriately determined depending on the requirement in the use. In the present invention, the particle wire longer than several hundreds of μm can be manufactured by selecting the kinds of the organometal compound, the optically excitable organic compound, and the reactive organic compound, and by adjusting the partial pressure, the irradiation conditions, the shape of the reaction vessel, and others.

The number of connected particles in the particle wire to be manufactured may also be appropriately determined depending on the requirement in the use. The number of connected particles is preferably 10 or more, more preferably 20 or more, and further preferably 50 or more, as long as they are utilized as the wire.

A particle wire manufactured according to the present invention can be utilized as a material for manufacturing components of various electronic devices, such as a conductive nanowire (microwire), for example, as a catalyst material, and a material for manufacturing a luminescent nanowire applicable to optical communications, and others.

### EXAMPLE

While the present invention will be described in detail below in reference to embodiments, the present invention is not limited to these embodiments.

### Example 1

The liquids of Co(CO)₃NO Fe(CO)₅, and ATMeSi were degassed by freeze-pump-thaw cycles in a vacuum line, and then purified by vacuum distillation. To prepare a gaseous mixture each vapor was introduced successively into a cross-shaped glass cell (long axis: inner diameter 35 mm, length 160 mm; short axis: inner diameter 20 mm, length 80 mm) through a vacuum line equipped with a capacitance manometer (Edward Barocel Type 600). Thus, a gaseous mixture with partial pressures of 3.5 Torr, 1.4 Torr, and 8.0 Torr for Co(CO)₃NO, Fe(CO)₅, and ATMeSi, respectively, was prepared.

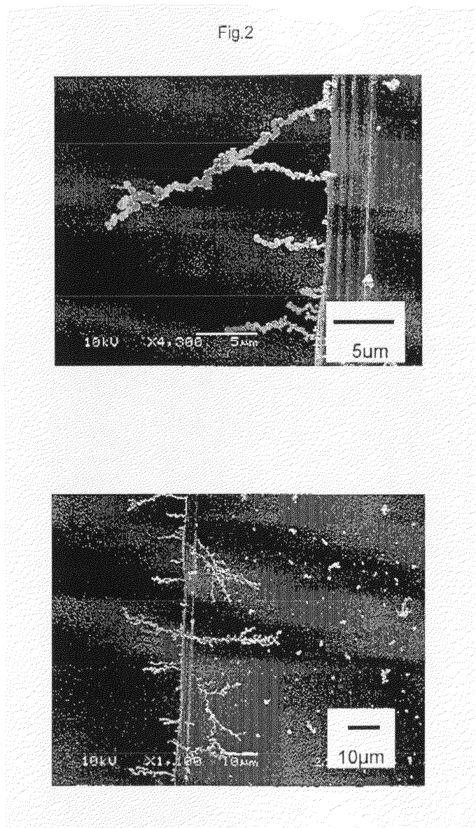

After waiting for 15 minutes to allow for the gaseous molecules to diffuse homogeneously within the reaction vessel, the gaseous mixture was irradiated at 313 nm for 3 minutes using a medium pressure mercury lamp (Ushio Inc., UM-452, 450 W) through glass filters (UV29 and UV-D33S), resulting in the production of wire-like solid material composed of the particles connected to each other. The length of the particle wire is several tens of μm. FIG. 2 shows a SEM image of the resulting wire-like solid product.

Chemical composition of the solid products was analyzed with a scanning electron microscope equipped with an X-ray microanalyzer (EDX-SEM). The solid product involved Fe, Co, and Si atoms by 7.7, 13.6, and 1.1 atomic percents, respectively, with the remainder composed of carbon and oxygen.

### Example 2

Under the same conditions as those of the first embodiment, except that the partial pressures of Co(CO)₃NO, Fe(CO)s, and ATMeSi were reduced to 2.6 Torr, 0.5 Torr, and 3.9 Torr, respectively, the wire-like solid materials having the length of several tens of μm were produced from the gaseous mixture.

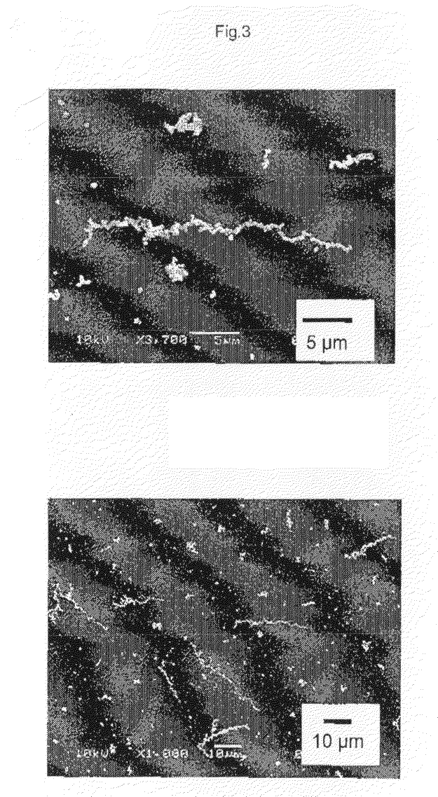

FIG. 3 shows a SEM image of the resulting wire-like solid product.

The analysis of the chemical composition of the resulting solid products using a scanning electron microscope equipped with an X-ray microanalyzer (EDX-SEM) revealed that the solid products involved Fe, Co, and Si atoms by 7.6, 12.9, and 0.4 atomic percents, respectively, with the remainder composed of carbon and oxygen.

### Example 3

The liquids of Fe(CO)₅, CS₂, and ATMeSi were purified and vaporized in the same way as in the first embodiment. To prepare a gaseous mixture, each vapor was introduced successively into a cross-shaped glass cell (long axis: inner diameter 35 mm, length 155 mm; short axis: inner diameter 20 mm, length 80 mm). The resulting partial pressures of the gaseous mixture were 1.4 Torr, 3.3 Torr, and 16.0 Torr for Fe(CO)₅, CS₂, and ATMeSi, respectively.

The gaseous mixture thus prepared was irradiated with the stationary light at 313 nm for 12 minutes in the same way as in the first embodiment, resulting in production of the wire-like solid material composed of the particles of 0.4 μm in diameter connected to each other. The mean length of the particle wire is 17 μm.

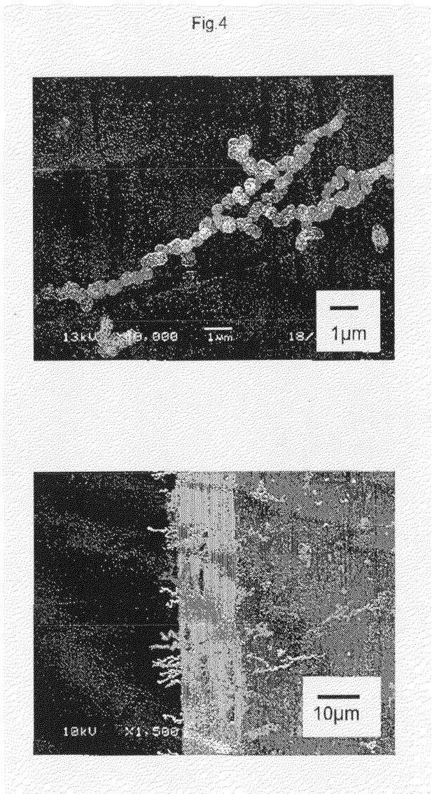

FIG. 4 shows a SEM image of the resulting wire-like solid product.

### Example 4

From a gaseous mixture of Fe(CO)₅, CS₂, and ATMeSi with partial pressures of 1.7 Torr, 9.5 Torr, and 16.0 Torr, respectively, the wire-like solid material with a mean length of 850 μm which was composed of the particles of 0.4 μm in diameter being connected to each other was produced under the same conditions as in the third embodiment.

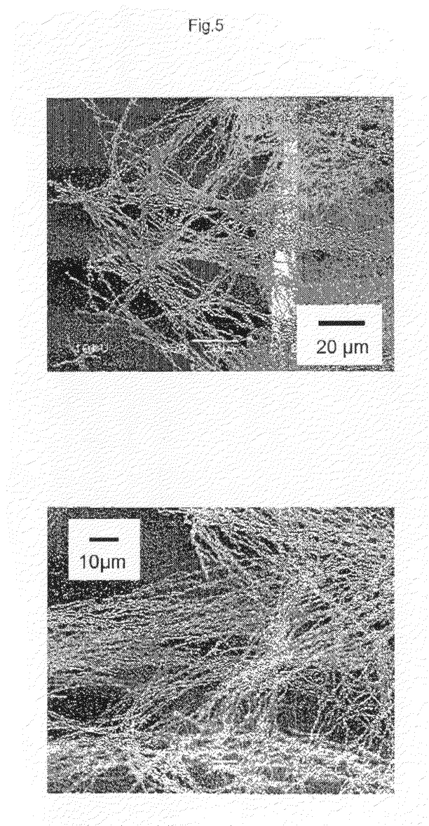

FIG. 5 shows a SEM image of the resulting wire-like solid product.

The analysis of the chemical composition of the resulting solid products with a scanning electron microscope equipped with an X-ray microanalyzer (EDX-SEM) revealed that the solid product involved Fe, S, Si, C, and O atoms by 10.0, 4.0, 0.6, 51.9, and 33.6 atomic percents, respectively.

### Example 5

The liquids of Fe(CO)₅, CS₂, and ATMeSi were purified and vaporized in the same way as in the first embodiment. To prepare a gaseous mixture, each vapor was introduced successively into a cross-shaped glass cell (long axis: inner diameter 35 mm, length 155 mm; short axis, inner diameter 20 mm, length 80 mm). The resulting partial pressures of the gaseous mixture were 1.7 Torr, 9.5 Torr, and 16.0 Torr for Fe(CO)₅, CS₂, and ATMeSi, respectively.

The gaseous mixture thus prepared was intermittently irradiated with the light at 313 nm in the same way as in the first embodiment with the intervals of 7 minutes between repeated 10 times light irradiation for 1-minute, repeated 5 times light irradiation for 2-minutes, and repeated 2 times light irradiation for 5-minutes. After the intermittent light irradiation for totally 30 minutes, the gaseous mixture produced the wire-like solid material with a mean length of 80 μm which was composed of the particles being connected to each other.

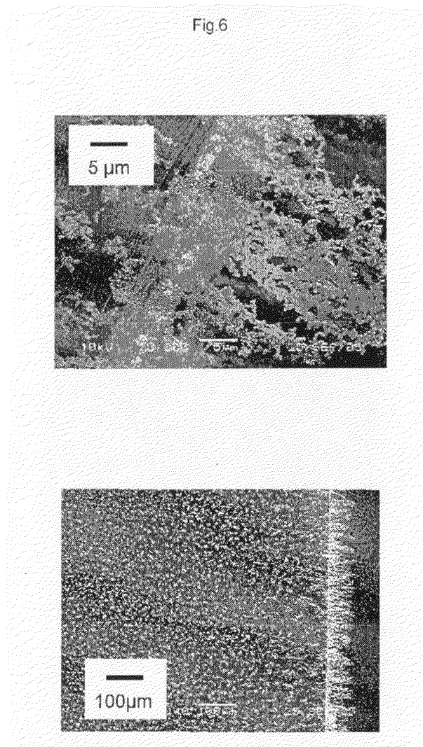

FIG. 6 shows a SEM image of the resulting wire-like solid product.

### Example 6

The liquids of Co(CO)₃NO and ATMeSi were purified and vaporized in the same way as in the first embodiment. To prepare a gaseous mixture, each vapor was introduced successively into a cross-shaped glass cell (long axis; inner diameter 35 mm, length 160 mm; short axis; inner diameter 20 mm, length 80 mm). The resulting partial pressures of the gaseous mixture were 1.5 Torr and 1.4 Torr for Co(CO)₃NO and ATMeSi, respectively.

The gaseous mixture thus prepared was intermittently irradiated with the light at 313 nm in the same way as in the first embodiment with the intervals of 10 minutes between repeated light irradiation for 10 seconds, 30 seconds, 80 seconds, 2 minutes, 6 minutes, and 10 minutes. After the intermittent light irradiation for totally 20 minutes, the gaseous mixture produced the wire-like solid material with a mean length of 250 μm which was composed of the particles of 0.2 μm in diameter being connected to each other.

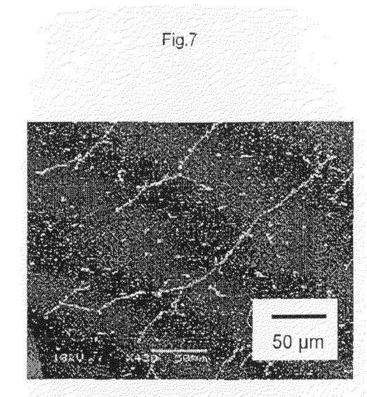

FIG. 7 shows a SEM image of the resulting wire-like solid product.

### Example 7

The gaseous mixture was prepared in the same way as in the sixth embodiment, except that the partial pressure of ATMeSi was increased to 9.8 Torr. The gaseous mixture thus prepared was intermittently irradiated with the light at 313 nm with the intervals of 10 minutes between repeated 2 times light irradiation for 10 seconds, light irradiation for 20 seconds, 30 seconds, 50 seconds, repeated 2 times light irradiation for 1 minute, and light irradiations for 2 minutes, 3 minutes, 4 minutes, 6 minutes, and 8 minutes. After the intermittent light irradiation for totally 27 minutes, the gaseous mixture produced the wire-like solid material with a mean length of 25 μm and thickness of 0.2 μm.

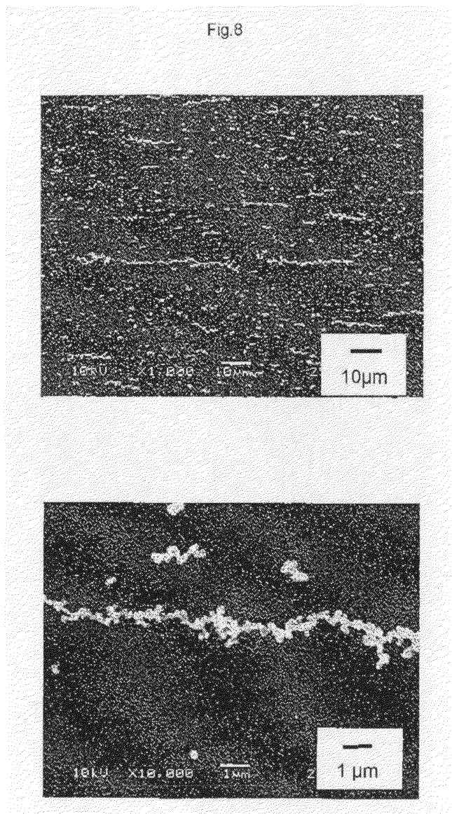

FIG. 8 shows a SEM image of the resulting wire-like solid product.

### Example 8

The liquid of Fe(CO)₅ was purified and vaporized in the same way as in the first embodiment, and then the vapor of 0.2 Torr was introduced into a cross-shaped glass cell (long axis: inner diameter 35 mm, length 155 mm; short axis; inner diameter 20 mm, length 80 mm). The pure gas thus prepared was intermittently irradiated with the light at 313 nm in the same way as in the first embodiment with the intervals of 7 minutes between repeated 5 times light irradiation for 1-minute, light irradiation for 2 minutes and 3 minutes, repeated 2 times light irradiation for 5 minutes, and light irradiation for 10-minutes, After the intermittent light irradiation for totally 30 minutes, the pure vapor produced the wire-like solid material with a mean length of 50 μm composed of the particles connected to each other.

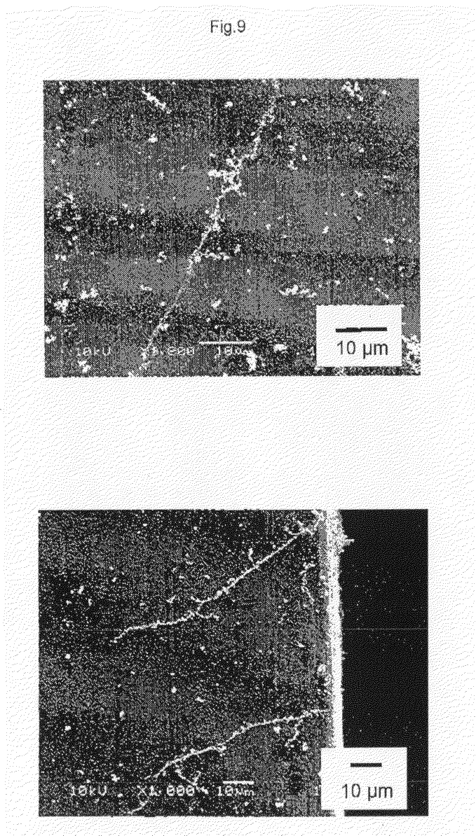

FIG. 9 shows a SEM image of the resulting wire-like solid product.

The present invention is not limited to the specifically disclosed embodiments, and variations and modifications may be made without departing from scope of the present invention.

The present application is based on Japanese priority application NO. 2007-219987 filed on Aug. 27, 2007, the entire contents of which are hereby incorporated by reference.

We claim:

1. A method of manufacturing a particle wire formed of particles connected to each other, comprising the steps of:
(1) preparing a vapor or gas of an organometal compound and, if required, a vapor or gas of an optically excitable organic compound and/or a vapor or gas of a reactive organic compound;
(2) introducing the vapor or gas prepared in the step (1) into a reaction vessel; and
(3) irradiating the vapor or gas introduced into the reaction vessel in the step (2) with a light having a wavelength which is absorbed by at least one of the organometal compound and the optically excitable organic compound.

2. The method of manufacturing the particle wire according to claim 1, wherein the organometal compound is Co(CO)₃NO and/or Fe(CO)₅.

3. The method of manufacturing the particle wire according to claim 1 or 2, wherein the optically excitable organic compound is carbon disulfide.

4. The method of manufacturing the particle wire according to claim 1, wherein the reactive organic compound is allyltrimethylsilane.

5. The method of manufacturing the particle wire according to claim 1 wherein the wavelength region of the irradiating light in the step (3) is between 250 and 400 nm.

6. The method of manufacturing the particle wire according to claim 1, wherein light irradiation in the step (3) is continuous irradiation for no longer than a predetermined period of time.

7. The method of manufacturing the particle wire according to claim 1 wherein light irradiation in the step (3) is intermittent irradiation.
